(19) United States
(12) Patent Application Publication
(10) Pub. No.: US 2019/0375232 A1
(43) Pub. Date: Dec. 12, 2019

(54) Artificial Celebration Cakes

(71) Applicant: Silvia Larsen, Woodstock, GA (US)

(72) Inventor: Silvia Larsen, Woodstock, GA (US)

(21) Appl. No.: 16/439,462

(22) Filed: Jun. 12, 2019

Related U.S. Application Data
(60) Provisional application No. 62/684,170, filed on Jun. 12, 2018.

(51) Int. Cl. B44F 11/00; A47G 7/06

(52) U.S. Cl. CPC B44F 11/00; A47G 2400/061; A47G 7/06

(57) ABSTRACT

Artificial Celebration Cakes are artificial cakes that are used to celebrate the life of the deceased. The cakes are artificial, but they are crafted to appear as if they are covered in buttercream, or fondant, like a traditional or custom designed cake. They are created by attaching one or more foam parts and attaching it to a vase insert, or temporary vase. This combination is meant to keep the artificial cake stable by allowing the cake to sit directly on the vase, while the vase insert is placed directly into the vase to prevent it from being blown over. The artificial cake can also be supported by a temporary vase when an affixed vase is not available, this will keep the artificial cake from being placed directly on the ground.

### CROSS-REFERENCE TO RELATED APPLICATIONS

This application claims the benefit of provisional patent application Ser. No. 62/684,170, filed 2018 Jun. 12 by the present inventor.

### TECHNICAL FIELD

This application relates to artificial cakes, which can be used as cemetery arrangements.

### BACKGROUND—PRIOR ART

The most common way to decorate a final resting place are with floral arrangements, which are usually placed in a cemetery vase that is affixed to a deceased person's final resting site. If a vase is not present or available, they can also be placed in a temporary vase. Since cemetery arrangement are mostly limited to flower arrangements, during special occasions, it is also common to decorate with balloons. The outdoor elements are not kind to balloons, especially during high winds, which can cause the balloon's strings to snap and fly away. A cake form covered in artificial flowers is another option. This cake form coated in artificial or fresh flowers can be placed on the ground on the deceased person's resting place. Unfortunately, if items or mementos are used to decorate a gravesite and left on the ground, the groundskeeper will usually dispose of these items prematurely, because it interferes with their landscaping duties.

### SUMMARY

An artificial cake that has been crafted to appear edible, can be used to celebrate the life of the deceased. The attachments used can give the cake stabilization by allowing it to be inserted directly in a cemetery vase, which would only expose the cake, because it would be sitting on the vase. It would also keep the cake from being placed directly on the ground.

### DRAWINGS—FIGURES

FIG. 1 illustrates a cake tier with additional tier options, a floral stick, a vase insert, and an example of a cemetery vase.

FIG. 2 illustrates how lines 1 through 3 would appear assembled prior to being inserted in the cemetery vase.

FIG. 3 illustrates an assembled cake that has been inserted into a cemetery vase.

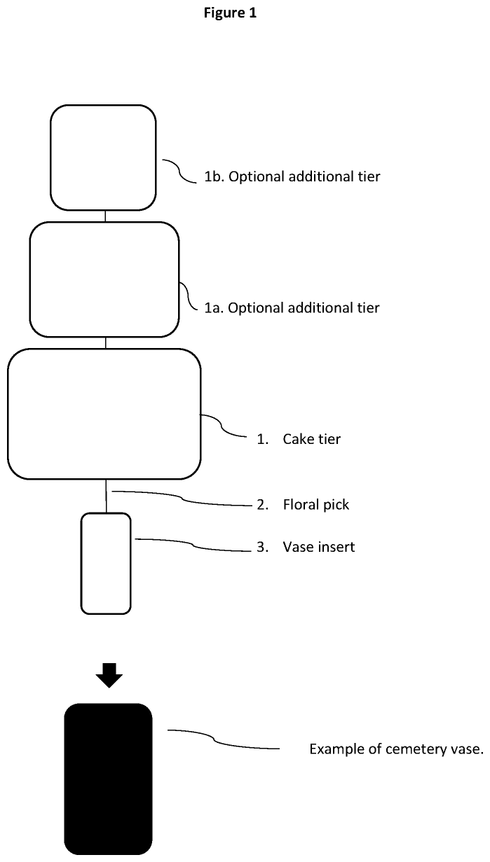

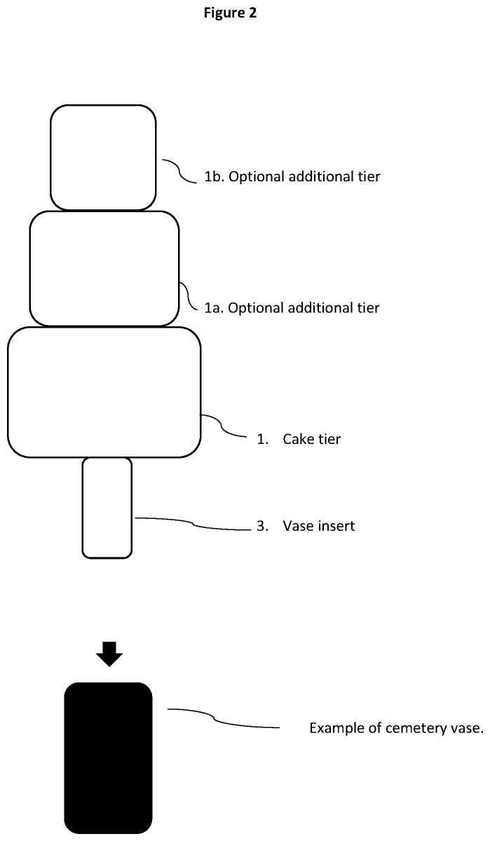

### DRAWINGS—REFERENCE NUMERALS

| | |
|---|---|
| 1 | Cake tier |
| 2 | Floral stick |
| 3 | Vase insert |
| 4 | Foam |
| 5 | Temporary vase |

### DESCRIPTION

The advantages of having a realistic looking cake with an attachment that can be used on a final resting place are: it is another way to celebrate the life of the deceased, it can endure the outdoor elements, it will not attract insects, the attachment under the cake will keep it from being blown away, and it will not interfere with the groundskeeper's work.

An Artificial Celebration Cake is a combination of an artificial cake 1 that has been crafted to appear like an edible cake covered in fondant or buttercream, and a vase insert 3, or a temporary vase 5. The Artificial Celebration Cakes can take the appearance of a traditional or custom cake. The combination of the cake 1 and vase insert 3 are used for final resting places that have an affixed vase to their resting site. The combination of the cake 1 and temporary vase 5 are for final resting places that do not have an affixed vase available.

The Artificial Celebration Cakes can be made to appear real by using various inedible products that will mimic the appearance of a cake 1 covered in buttercream or fondant. The shape of the desired cake 1 can be achieved through pre-shaped foam. Wood filler, joint compound, a paintable coating, and spackle can all be used to mimic the buttercream texture. These would be applied to the cake 1 foam in the same manner as frosting a cake. To make it appear as smooth as fondant, those same products would need to be sanded down; clay can also be used to mimic the fondant texture.

Once the desired look is achieved, the artificial cake 1 can be painted to the color of choice with paint. The artificial cake 1 can then be decorated with other embellishments like glitter, ribbon, flowers, glue with color, or words and objects that can be cut by craft machines. If it is an artificial cake 1 with more than one cake tier 1a, glue can be used to secure one tier on top of the other. When completed, the artificial cake 1 can then be sealed with a clear outdoor glue, or other clear sealants to protect it from the outdoor elements.

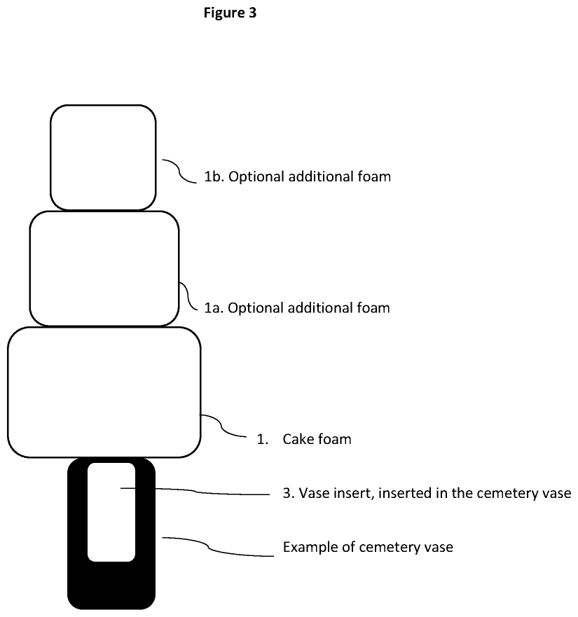

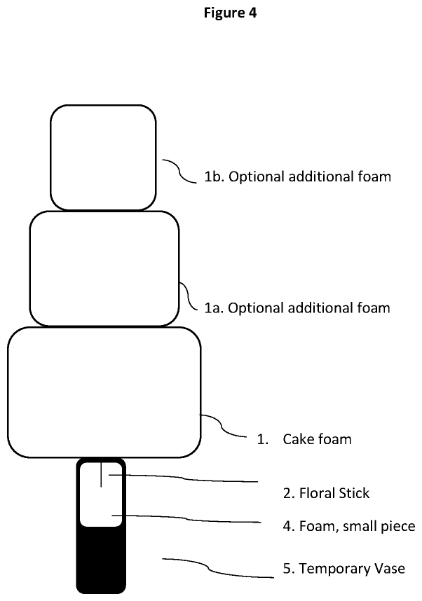

The artificial cake 1 can now be combined with a vase insert 3 or a temporary vase 5. The vase insert chosen should be able to fit the affixed vase, because many cemetery vases vary by size. If the vase insert does not have its own attachment piece to mount on the artificial cake, the vase insert 3 can be attached to the artificial cake 1 using an outdoor glue that is safe to use on foam; for added stabilization, a floral stick 2 can be used to secure the artificial cake 1 to the vase insert 3. If a temporary vase 5 is to be used, it can also be glued to the artificial cake 1; for added stabilization, a small piece of foam 4 can be inserted into the vase 5, so that a floral stick 2 can be used as another connection point between the artificial cake and the vase. An artificial cake can be used for a gravesite, tomb, mausoleum, columbarium, a niche, and urns that are kept at home. An artificial cake with an attached vase insert can slide into an existing affixed vase and will appear as shown in FIG. 3. The artificial cakes with a temporary vase can be secured to the Earth, or a structure, FIG. 4.

Artificial cakes are comparable in appearance to edible cakes, but the weight is not. The completed product is a lightweight artificial cake that can weigh under lib; weight will vary depending on size and embellishments used. The instructions given as to how to accomplish the appearance of the artificial cakes are not limited to these methods and should not be construed as such. Although these cakes were mainly intended for cemetery use, they can also be used without an attachment for indoor and outdoor decorations.

1. An artificial cake that appears to be a traditional or custom decorated cake, can be used indoors or outdoors.

2. The artificial cake of claim 1 can be combined with the correct size attachment to be inserted in an affixed cemetery vase.

3. The artificial cake of claim 1 can be combined with a temporary vase that can be inserted into the earth.
